(19) United States
(12) Patent Application Publication
(10) Pub. No.: US 2014/0224804 A1
(43) Pub. Date: Aug. 14, 2014

(54) WELDED PULL-DOWN TAB CONTAINER

(71) Applicant: Strategic Global Sourcing, LLC, Diamond Springs, CA (US)

(72) Inventor: Charles Pickering, EI Dorado, CA (US)

(73) Assignee: Strategic Global Sourcing, LLC, Diamond Springs, CA (US)

(21) Appl. No.: 14/171,979

(22) Filed: Feb. 4, 2014

Related U.S. Application Data
(60) Provisional application No. 61/760,999, filed on Feb. 5, 2013.

(51) Int. Cl. B65D 85/72; B29C 65/00; B65D 43/26

(52) U.S. Cl. CPC B65D 85/72; B65D 43/26; B29C 65/00
USPC 220/270; 156/292

(57) ABSTRACT

A two-piece tamper-evident and tamper-resistant container having a base, a lid and a welded hinge connecting the lid and base to one another for use in packing, identifying and selling fresh food items and the like. A rim about an upper periphery of the base engages an identically contoured flange about a lower periphery of the lid, and a protective lip integral to and extending from an outermost end of the rim prevents access to the lip making a pull-tab of the frangible hinge the only possible access point of the container. Any tampering to access the inside of the container would be made evident by a broken or separated hinge.

### RELATED APPLICATION

This application claims the filing priority of U.S. Provisional Application No. 61/760,999, filed Feb. 5, 2013. The '999 application is hereby incorporated by reference.

### TECHNICAL FIELD

The present invention relates to containers used primarily for foodstuff, but suitable for other materials as well. More particularly, the invention relates to hinged containers with tamper-evident/tamper-resistant features.

### BACKGROUND OF THE INVENTION

The purpose of a tamper-evident/tamper-resistant container is two-fold. First, it is to provide evidence of a correctly opened package after a proper closure. Second, it is to provide resistance from product tampering after a product is packaged and before a customer purchases the product. Of course, there are limitations to these features as used in prior tamper-evident and tamper-resistant containers.

The “tamper-resistant” quality of a container carries no guarantee that a container can only be opened by the use of the opening feature provided. However, it does typically make the process of opening by any other method very challenging. In some instances, the challenge is too easily overcome and consumers may unwittingly purchase a product in a container that has been breached in some manner because such a breach is not evident.

The “tamper-evident” quality of a container involves the use of an opening feature which provides evidence that the container has been opened. However, it does not prevent a container from being opened in other ways which may avoid the “tamper-evident” feature, even though opening of the package in any other way would be a willful act of deceit.

The packaging design of the presently disclosed container is created for use in both hand packing processes as well as for use with automated closing lines. The disclosed container is directed to solving the above problems as well as others faced by prior containers used in the applicable field.

### SUMMARY OF THE INVENTION

The present disclosure is directed to a two-piece container and methods for making such a container. Generally speaking, the container is comprised of a lid, a base and a hinge which allows the two components to be properly closed in a manner which provides both “tamper-evident” and “tamper-resistant” packaging. The container is most commonly used in the food industry for fresh foods and the like.

In a specific embodiment, the two-piece container comprises a base having a rim about an upper periphery, a protective lip extending from an outermost end of the rim and a first weldable hinge portion extending outward along a portion of the rim, and a lid comprising a flange about a lower periphery, the flange terminating at an outermost end, and a second weldable hinge portion extending outward along a portion of the flange. The first weldable hinge portion overlaps with the second weldable hinge portion, and the two hinge portions are welded together to form a frangible hinge between the base and the lid.

Preferably, one of the two halves—i.e., the lid and the base, and most preferably the base—includes a pull tab for facilitating opening of the container.

In other embodiments of the two-piece container the base is comprised of a first suitable material and the lid is comprised of a second suitable material, different from the first suitable material. Similarly, the base may have a substantial thickness different from the thickness of the lid. Moreover, the suitable material of the base may be of a color different than a color of the suitable material of the lid.

In another embodiment of the two-piece container, a surface of the outermost end of the flange has an angle, relative to an adjacent surface, which is less than an angle of an outermost surface of the rim, relative to an adjacent surface corresponding to the adjacent surface of the lid. Preferably, the angle of the flange surface is in the range of from about 2 to about 10 degrees less than and the angle of the rim surface. Most preferably, the angle of the flange surface is about 5 degrees less than the angle of the rim surface.

In a preferred method for forming a tamper-resistant and tamper-evident two-piece container, the steps include forming a base for the container, the base comprising a rim about an upper periphery, a protective lip integral to and extending from an outermost end of the rim and a first weldable hinge portion positioned along a portion of the rim, forming a lid for the container, the lid comprising a flange about a lower periphery, the flange terminating at an outermost end, and a second weldable hinge portion positioned along a portion of the flange corresponding to the portion of the rim having the first weldable hinge portion, and then welding the first weldable hinge portion of the base to the second weldable hinge portion of the lid to form a hinge connecting the lid to the base. The rim and flange have complimentary contours such that the flange snap fits within the periphery of the rim and the outermost end of the flange is positioned adjacent the protective lip of the base to prevent access to the end.

These and other features of the two-piece container and methods will be more readily understood from a reading of the following detailed description, including the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of one embodiment of the present two-piece container in an open, hinged condition;

FIG. 2 is another perspective view of the embodiment of FIG. 1 showing the two-piece container in an closed, hinged condition;

FIG. 3 is top view of the embodiment of FIG. 1 showing the two-piece container in a closed condition;

FIG. 4 is a bottom view of the embodiment of FIG. 1 in an open, hinged, flat condition;

FIG. 5 is a bottom view of the embodiment of FIG. 1 in an open, unhinged, flat condition;

FIG. 6 is a close-up perspective view of an embodiment of a hinge of a two-piece container in accordance with the present disclosure;

FIG. 7 is a perspective view of another embodiment of a two-piece container in an open and hinged condition; and

FIG. 8A and 8B are side-by-side cross sections of a typical flange design (FIG. 8A) and an embodiment of a flange design of the present invention (FIG. 8B).

### DETAILED DESCRIPTION OF A PREFERRED EMBODIMENT

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

For example, the appended drawing figures only illustrate a rectangular two-piece container. However, the container may be of most any shape and size, including various possible depths for both portions. Other advantages and alternatives will be mentioned throughout the following detailed description.

Further, though the container itself is unique, as will be described below in greater detail, methods for producing the container may also be considered inventive. Such inventive methods include directly connecting separately formed packaging components (e.g., a lid and a base) by welding integral hinge portions (or flaps) on each of the two components together in a manner that they can be torn, broken or separated at a later time. By directly connecting the two rigid components by these hinge portions, the connection functions as a hinge to create a hinged container. This hinged container provides a self-evident opening feature by showing clear evidence of the container having been opened after it had been properly closed.

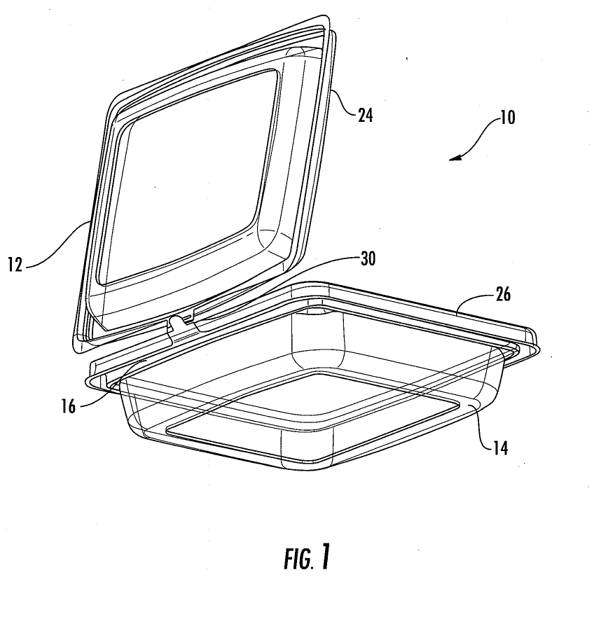

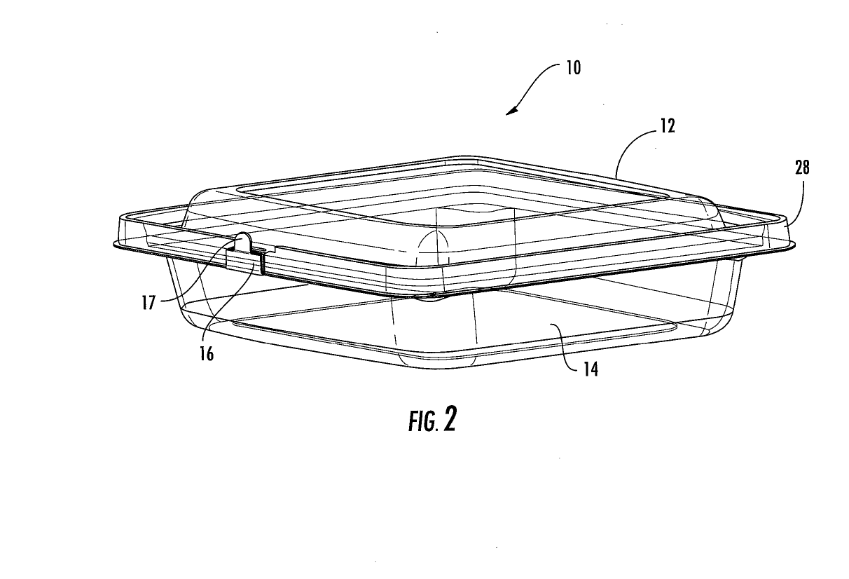

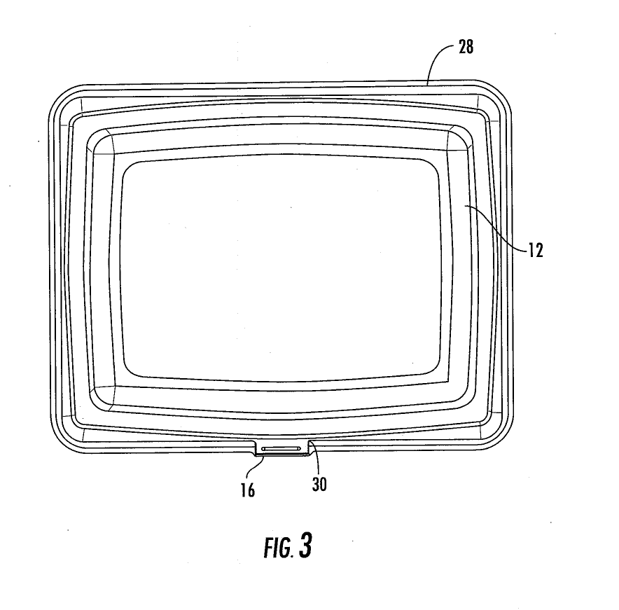

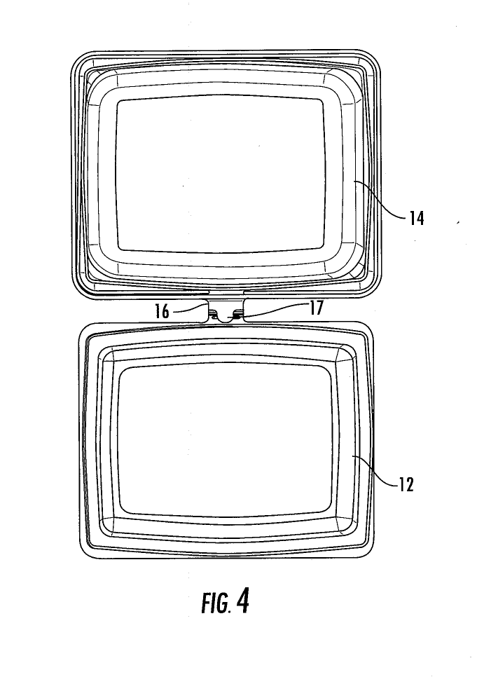

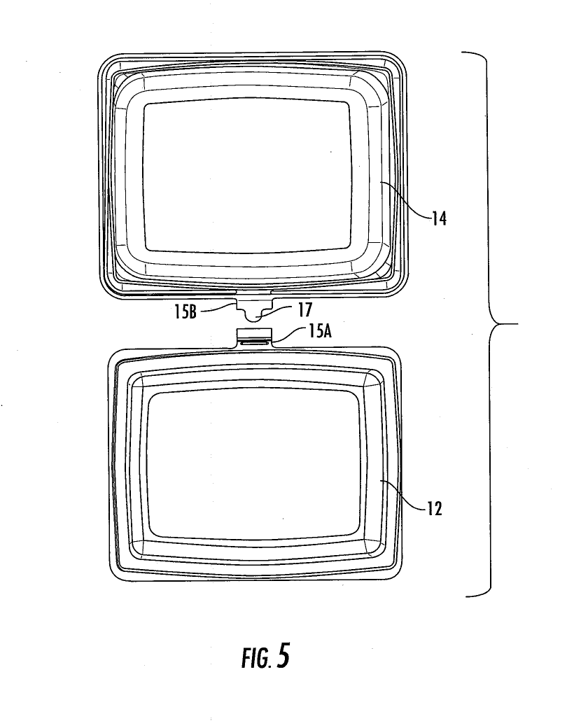

Referring now to FIGS. 1-6, an embodiment of a two-piece container is shown and generally indicated by the reference number 10. The container 10 is comprised of a lid 12 and a base 14, each including a hinge portion 15A, 15B, respectively. One of the two hinge portions 15A, 15B further comprises a flap or pull-tab 17. The two portions are connected together to form a hinge 16, with the hinge portion having the pull-tab 17 being positioned on top of the other portion. In this way, the pull-tab 17 can be accessible to facilitate opening of the container 10.

The lid 12 and base 14, including their respective hinge portions 15 and the pull-tab 17, can be comprised of a number of materials, with each part being formed of the same, similar, or completely different materials, as desired. The preferred materials include polyethylene terephthalate (PET), polystyrene (PS), high-impact polystyrene (HIPS), oriented polystyrene (OPS), polypropylene (PP), and polylactic acid (PLA) as well as other polymers, monomers or laminated structures used in packaging, primarily for foods.

Likewise, the resulting welded hinge 16 would be made from these same various materials, as it is formed of two hinge portions 15A, 15B welded, glued or otherwise connected together. The weld may be a heat weld, a chemical weld or the result of adhesives applied to surfaces of the two hinge portions 15A and 15B. The frangible hinge 16 may also include forms of scoring to better allow hinging and/or tearing of the hinge 16 upon opening.

With respect to manufacture and assembly of container 10, the two individual components, i.e., the lid 12 and base 14, are thermoformed individually and separately using industry standard equipment and processes. The illustrated pull-tab 17 is preferably designed in the hinge flap 15 of the base 14. Ultimately, the two components will be trimmed out, scored, perforated (as necessary) and placed together on another piece of equipment where the hinge portions 15 can be welded to form hinge 16. There are benefits to forming the lid 12 and base 14 components individually prior to welding the hinge 16 to create the hinged container 10.

Some of the benefits of separating the overall process include allowing the base 14 and lid 12 to be formed from different types of material (as mentioned above), different thicknesses of material and the potential of using different colors to contrast the base 14 from the lid 12. While co-extruding materials and manufacturing colored bases with clear lids for hinge containers is common, having a hinge container (lid connected to the base) with two different materials, e.g., a polypropylene base and an OPS lid, or a thinner material in the clear lid and thicker material in the colored base, has not been done before and is completely original.

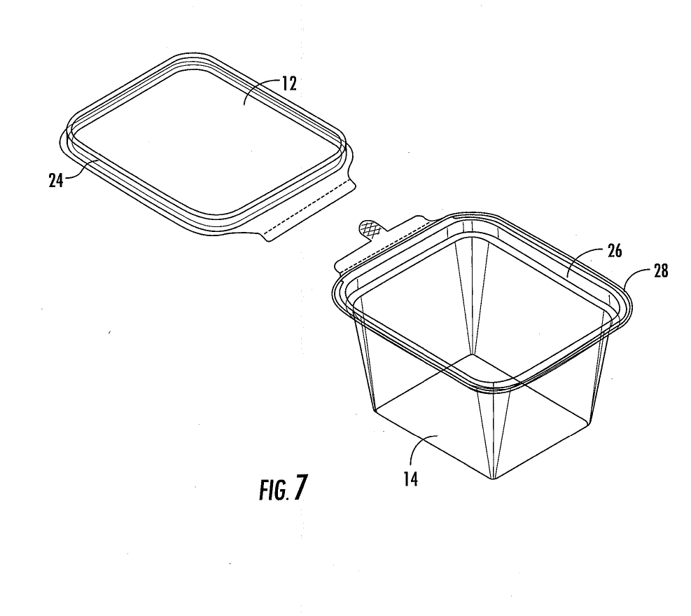

The potential for material cost savings is also significant. For example, as illustrated in FIG. 7, by pairing a flat or slightly domed lid 12 with a 3″ or deeper base 14, the container 10 of the present invention can provide an overall material savings in the range of 20-25%. In contrast, standard hinge containers have the same amount of material in the flat lid as they do in the deep base portion of the container.

FIGS. 1-3 show the lid 12 indirectly connected to the base 14, and hinged together by hinge 16 as formed by the respective hinge portions 15. After the lid 12 and base 14 are individually formed, a single, but not limited to one, score line on one of the two hinge portions 15 and a single, but not limited to one, perforated line on the other of the two hinge portions are overlapped (perforated line on the top side) to create the folding (hinge 16) line at the base of each hinge portion 15 for each of the lid 12 and the base 14.

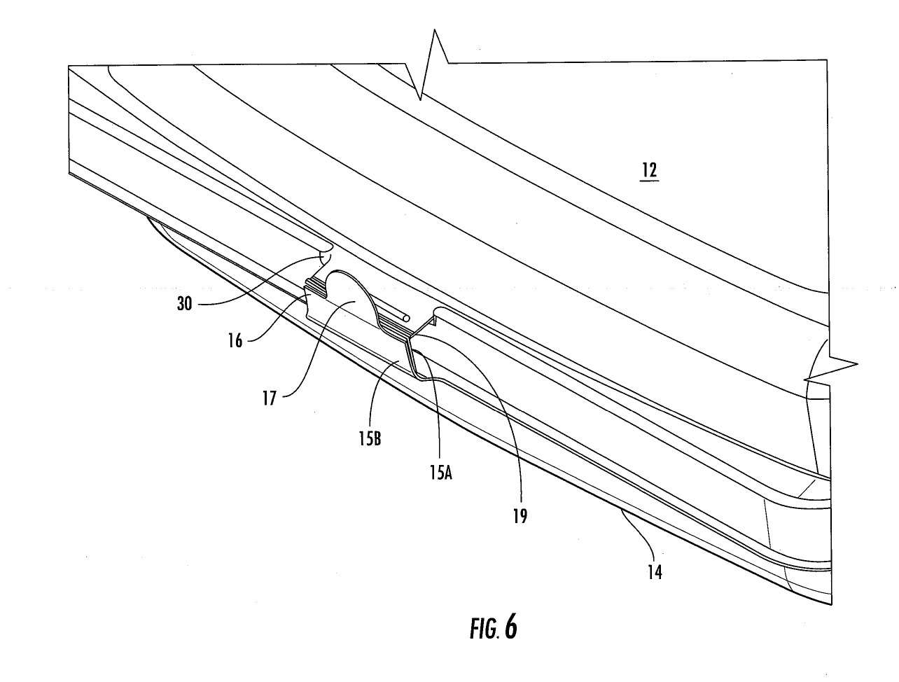

The formed lid 12 is directly connected to the base 14, which can hinge on the scored/perforated line (see FIG. 6). Connecting the two container halves together is accomplished by, but not limited to, welding or gluing the hinge portions 15 directly together to make one single frangible hinge 16 with a pull tab 17 to open the container 10 when the finished product is closed.

The welding process is preferably performed on a separate machine from that of the forming, scoring, perforating and trimming process. In a preferred method, the base 14 is typically loaded first so that the pull-tab 17 of the base 14 is facing up in the finished container 10. A device applies heat, pressure and/or a sonic weld to the overlapping hinge portions 15 which bonds the two portions in a fashion that allows them to be pulled apart or have the score line 19 of the lid 12 tear to open the container 10. This process allows the pull-tab 17 to remain attached to the base 14. Accordingly, to open the container 10, the pull tab 17 of the hinge 16 is pulled downward which tears or otherwise destroys the hinge 16. Alternatively, two perforated lines may be used to facilitate complete removal of the hinge 16 when the pull tab 17 is pulled.

FIG. 7 illustrates an alternate embodiment of the disclosed container in an open and unhinged condition (i.e., before welding). The container 10 shows a variation of the base 14 and lid 12 size, shape and depth. Obviously, many alternative embodiments exists by changing these and other non-critical factors and such embodiments would be understood by those skilled in the art. As with the previous embodiments, the hinge 16 acts as an indicator as to whether the container has been properly opened or not, i.e., the tamper-evident feature.

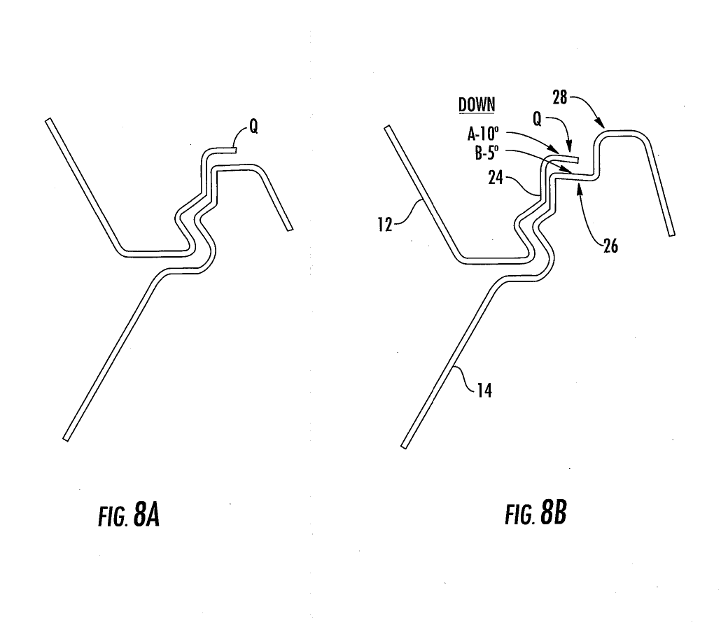

Referring now to FIGS. 8A and 8B, cut away views of a prior art lid and a base (FIG. 8A) and a lid 12 and base 14 of the present invention (FIG. 8B) showing the interfacing edges are illustrated. The lid 12 includes a peripheral flange 24 which, as shown, has a contour substantially identical to the contour of rim 26 of the base 14. This is true for the present container 10 and prior art containers, as evidenced by the side-by-side images. However, the present container also includes a protective lip 28 extending from and integral to the rim 26 of the base 14. It should be noted that a channel 30 is cut through the lip 28 at the label adhesion area 20, as shown best in FIGS. 1, 5 and 6, to prevent interference with the hinge label 16 and the allow for complete closure of the lid 12. This is important for a good seal between the lid 12 and base 14.

The outermost end “Q” (also known as the “trim edge”) of a typical lid flange design of the prior art containers shows the accessibility of the flange when the two components are in a closed/sealed condition. In contrast, the present container 10 is designed with the protective lip 28 extending from the rim 26 to prevent access to the outermost end (i.e., trim edge) of the lid flange 24.

In addition, the surface of the outermost edge of the flange 24 is preferably angled downward, relative to the adjacent surface, about two to ten degrees less than the angle of the corresponding rim surface, relative to the adjacent surface. As measured from an imaginary horizontal plane, the rim surface (“A”) is angled downward (moving outwardly) from about two to about eight degrees, while the flange surface (“B”) is angled downward (moving outwardly) from about five to about 15 degrees. This feature provides greater resistance to deceitful opening of the container or, as is known in the art, “tamper-resistant.”

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A two-piece container comprising:
a base comprising a rim about an upper periphery, a protective lip extending from an outermost end of the rim and a first weldable hinge portion extending outward along a portion of the rim; and
a lid comprising a flange about a lower periphery, the flange terminating at an outermost end, and a second weldable hinge portion extending outward along a portion of the flange;
wherein the flange of the lid engages the rim of the base to form a closed container, one of either the first weldable hinge portion and the second weldable hinge portion comprises a pull-tab and the weldable hinge portion with the pull-tap overlaps the other weldable hinge portion such that the two hinge portions are welded together to form a frangible hinge between the base and the lid.

2. The two-piece container of claim 1, wherein the base is comprised of a first suitable material and the lid is comprised of a second suitable material, different from the first suitable material.

3. The two-piece container of claim 2, wherein the base has a substantial thickness and the lid has a substantial thickness, the thickness of the base being different from the thickness of the lid.

4. The two-piece container of claim 2, wherein the suitable material of the base is of a color different than a color of the suitable material of the lid.

5. The two-piece container of claim 2, wherein the first and second suitable materials are selected from the group of polymers consisting of polyethylene terephthalate (PET), polystyrene (PS), high-impact polystyrene (HIPS), oriented polystyrene (OPS), polypropylene (PP), and polylactic acid (PLA).

6. The two-piece container of claim 1, wherein a surface of the outermost end of the flange has an angle, relative to an adjacent surface, less than an angle of an outermost surface of the rim, relative to an adjacent surface corresponding to the adjacent surface of the lid.

7. The two-piece container of claim 6, wherein the angle of the flange surface is in the range of from about 2 to about 10 degrees less than and the angle of the rim surface.

8. The two-piece container of claim 6, wherein the angle of the flange surface is about 5 degrees less than the angle of the rim surface.

9. The two-piece container of claim 1, wherein the closed container is opened using the pull-tab of the frangible hinge.

10. The two-piece container of claim 9, wherein the outermost end of the flange abuts the protective lip of the base to prevent access to the end for lifting the flange.

11. The two-piece container of claim 9, wherein the frangible hinge comprises at least one perforated line on the weldable hinge portion comprising a pull-tab.

12. The two-piece container of claim 9, wherein the frangible hinge comprises two perforated lines with one on each of the first and second weldable hinge portions.

13. A two-piece container comprising:
a base made of a first material and comprising a rim about an upper periphery, a protective lip extending from an outermost end of the rim and a first weldable hinge portion extending outward along a portion of the rim; and
a lid made of a second material and comprising a flange about a lower periphery, the flange terminating at an outermost end, and a second weldable hinge portion extending outward along a portion of the flange;
wherein the flange of the lid engages the rim of the base to form a closed container, one of either the first weldable hinge portion and the second weldable hinge portion comprises a pull-tab, and the weldable hinge portion having the pull-tab overlaps and is welded to the other weldable hinge portion to form a frangible hinge between the base and the lid to facilitate opening of the container when closed.

14. The two-piece container of claim 13, wherein a surface of the outermost end of the flange has an angle, relative to an adjacent surface, less than an angle of an outermost surface of the rim, relative to an adjacent surface corresponding to the adjacent surface of the lid.

15. The two-piece container of claim 14, wherein the angle of the flange surface is in the range of from about 2 to about 10 degrees less than and the angle of the rim surface.

16. The two-piece container of claim 14, wherein the angle of the flange surface is about 5 degrees less than the angle of the rim surface.

17. The two-piece container of claim 13, wherein the frangible hinge comprises at least one perforated line on the weldable hinge portion comprising a pull-tab.

18. A method for forming a tamper-resistant and tamper-evident two-piece container comprising the steps of:
forming a base for the container, the base comprising a rim about an upper periphery, a protective lip integral to and extending from an outermost end of the rim and a first weldable hinge portion positioned along a portion of the rim;
forming a lid for the container, the lid comprising a flange about a lower periphery, the flange terminating at an outermost end, and a second weldable hinge portion positioned along a portion of the flange corresponding to the portion of the rim having the first weldable hinge portion, wherein one of either the first and second weldable hinge portions comprises a pull-tab; and
welding the first weldable hinge portion of the base to the second weldable hinge portion of the lid, with the portion having a pull-tab positioned to overlap the other portion and thereby form a frangible hinge connecting the lid to the base;
wherein the rim and flange have complimentary contours such that the flange snap fits within the periphery of the rim and the outermost end of the flange is positioned adjacent the protective lip of the base to prevent access to the end.

19. The method of claim 18, wherein the lid and base are formed of different materials.
